(19) United States
(12) Patent Application Publication
(10) Pub. No.: US 2026/0226329 A1
(43) Pub. Date: Aug. 6, 2026

(54) Solventless Adhesive Composition

(71) Applicant: ARKEMA FRANCE, Puteaux (FR)

(72) Inventors: Praveen Agarwal, Lake Jackson, TX (US); Tuoqi Li, Bellevue, WA (US); Alexander Williamson, Lake Jackson, TX (US); Yinzhong Guo, Lake Jackson, TX (US)

(73) Assignee: ARKEMA FRANCE, Puteaux (FR)

(21) Appl. No.: 19/154,071

(22) PCT Filed: Jan. 17, 2024
(86) PCT No.: PCT/US2024/011730

§ 371 Date: Aug. 6, 2025

Related U.S. Application Data
(60) Provisional application No. 63/483,546, filed on Feb. 7, 2023.

(51) Int. Cl. C09J 175/08; B32B 7/12; B32B 27/08; B32B 27/34; B32B 27/36; B65D 65/40; C08G 18/10; C08G 18/34; C08G 18/40; C08G 18/66; C08K 5/521; C09J 11/06

(52) U.S. Cl. CPC C09J 175/08; B32B 7/12; B32B 27/08; B32B 27/34; B32B 27/36; B65D 65/40; C08G 18/10; C08G 18/348; C08G 18/4018; C08G 18/6692; C09J 11/06; C08K 5/521

(57) ABSTRACT

A two-component solventless adhesive composition, including: (a) at least one isocyanate component comprising an isocyanate-terminated polymer; and (b) at least one isocyanate-reactive component being reactive with the at least one isocyanate component, component (a); wherein the at least one isocyanate-reactive component, component (b), comprises a material having at least two functional groups including: (b′) at least one first functional group; wherein the at least one first functional group is selected from the group consisting of: at least one phosphate ester functional group, at least one phosphonic acid functional group, and mixtures thereof; and (b″) at least one second functional group reactive with the at least one isocyanate component, component (a); wherein the least one second functional group is selected from the group consisting of: at least one hydroxyl functional group, at least one carboxylic acid functional group, and mixtures thereof; a method for forming a laminate structure using the above solventless adhesive composition; and a laminate structure formed using the above method.

### FIELD

The present disclosure relates to solventless adhesive compositions; and more specifically, the present disclosure relates to high-performance two-component solventless polyurethane adhesive compositions for use in producing laminate structures.

### BACKGROUND

Adhesive compositions are used to bond together various substrates such as polyethylene, polypropylene, polyester, polyamide, metal, paper, or cellophane to form composite films, i.e., laminates; and such laminates can be used for different end-use applications. For example, it is known to use adhesives in the manufacture of film/film and film/foil laminates used in the packaging industry, especially for food packaging. Known adhesives used in laminating applications (or “laminating adhesives”) can be generally placed into three categories: solvent-based, water-based, and solventless. The performance of an adhesive varies by category and by the application in which the adhesive is applied.

Solventless laminating adhesives can be applied up to one hundred percent solids without either an organic solvent or an aqueous carrier. And, because no organic solvent or water has to be dried from the solventless adhesive upon application, solventless adhesives can be run at high laminating line speeds. On the other hand, solvent-based and water-based laminating adhesives are limited by the rate at which the solvent or water can be effectively dried and removed from the laminate structure after application of the adhesive. This is one reason the use of solventless adhesives is preferred over solvent-based adhesives. In addition, for environmental, health, safety, and energy consumption reasons, laminating adhesives are preferably solventless.

Within the category of solventless laminating adhesives, there are many varieties. One particular variety includes two-component, polyurethane-based laminating adhesives. Typically, the two-component (2K), polyurethane (PU)-based laminating adhesive includes a first component and a second component. The first component comprising an isocyanate-terminated prepolymer and the second component comprises a polyol. The isocyanate-terminated prepolymer (first component) can be obtained by the reaction of an excess of a polyisocyanate with a polyether polyol and/or a polyester polyol containing two or more hydroxy groups per molecule. The second component can comprise a polyether polyol and/or a polyester polyol containing two or more hydroxy groups per molecule. The first and second components are combined in a predetermined ratio to form an adhesive composition; and then, the adhesive composition is applied on a first substrate (also known as a “carrier web”). The first carrier web substrate is then brought together with a second substrate to form a laminate structure (the laminate composite). Additional layers of substrates can be added to the laminate structure with additional layers of adhesive composition applied and located between each successive substrate layer. After application of the adhesive to the substrates to form the laminate structure, the adhesive is cured, either at room temperature or elevated temperature, thereby bonding the substrates together.

Despite being preferred for environmental, safety, health, and energy consumption reasons, solventless adhesives often encounter issues such as poor chemical and thermal resistance, particularly in more demanding (i.e., “high performance”) applications (e.g., applications such as boil-in-bag, retort, and the like). Accordingly, it is desired to provide a 2K solventless PU-based laminating adhesive composition having improved chemical and thermal resistance. In addition, it is desired to provide a 2K solventless PU-based laminating adhesive composition that can be used in high-performance applications; and/or that can be used to laminate one or more metal or metallized films together.

### SUMMARY OF DISCLOSURE

The present disclosure is directed to two-component solventless adhesive compositions including (a) at least one isocyanate component comprising an isocyanate-terminated polymer; and (b) at least one isocyanate-reactive component that is reactive with the at least one isocyanate component, component (a); wherein the at least one isocyanate-reactive component, component (b), comprises a material having at least two functional groups including: (b′) at least one first functional group; wherein the at least one first functional group is selected from the group consisting of: at least one phosphate ester functional group, at least one phosphonic acid functional group, and mixtures thereof; and (b″) at least one second functional group reactive with the at least one isocyanate component, component (a); wherein the least one second functional group is selected from the group consisting of: at least one hydroxyl functional group, at least one carboxylic acid functional group, and mixtures thereof; and (c) optionally, at least one bio-based polyol.

The adhesive compositions of the present disclosure includes two-component solventless adhesive compositions comprising: (a) an isocyanate component comprising an isocyanate-terminated polymer, and (b) an isocyanate-reactive component comprising a hydroxy-terminated resin compound.

The two-component solventless adhesive compositions of the present disclosure can include (a) an isocyanate component comprising an isocyanate-terminated prepolymer, and (b) an isocyanate-reactive component comprising a hydroxy-terminated polyurethane resin, a polyether polyol, a phosphate ester adhesion promoter; and, optionally, a bio-based polyol.

The present disclosure can be directed to methods of preparing the above adhesive compositions.

The present disclosure further relates to methods for forming a laminate structure using the above adhesive compositions.

The adhesive compositions of the present disclosure advantageously exhibit improved properties compared to current solventless adhesive systems. For example, the improvement of the properties of the adhesive compositions of the present disclosure can include: fast curing increased adhesion to metalized films, and so on.

The adhesive compositions of the present disclosure and the methods for forming laminate structures using the adhesive compositions of the present disclosure advantageously provide adhesive compositions and laminates having improved chemical and thermal resistance compared to existing two-component solventless adhesive compositions. The adhesive compositions and laminates of the present disclosure having improved chemical and thermal resistance performance properties are particularly beneficial when the adhesive compositions and laminates are used in medium to high-performance applications; and/or, when the adhesive compositions are used to laminate one or more metal or metallized films.

### DETAILED DESCRIPTION

Specific embodiments of the present application are described herein below. These embodiments are provided so that this disclosure is thorough and complete and fully conveys the scope of the claimed subject matter of the present disclosure to those skilled in the art.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; etc.).

Unless stated to the contrary or otherwise, implicit from the context, or customary in the art, all percentages, parts, ratios, and the like amounts, are defined by, or based on, weight. For example, all percentages stated herein are weight percentages (wt. %), unless otherwise indicated. And, all test methods disclosed herein are current as of the filing date of this disclosure.

Temperatures herein are in degrees Celsius (° C.).

“Room temperature (RT)” and/or “ambient temperature” herein means a temperature between 20° C. and 26° C., unless specified otherwise.

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; Rm=micron(s), g=gram(s); mg=milligram(s); mW/m-K=milliWatt(s) per meter-degree Kelvin; L=liter(s); mL=milliliter(s); g/mL=gram(s) per milliliter; g/L=gram(s) per liter; kg/m³=kilogram(s) per cubic meter; ppm=parts per million by weight; pbw=parts by weight; rpm=revolutions per minute; m=meter(s); mm=millimeter(s); cm=centimeter(s); □m=micrometer(s); min=minute(s); s=second(s); ms=millisecond(s); hr=hour(s); Pa=pascals; MPa=megapascals; Pa-s=Pascal second(s); mPa-s=milliPascal second(s); g/mol=gram(s) per mole(s); g/eq=gram(s) per equivalent(s); mg KOH/g=milligrams of potassium hydroxide per gram(s); Mₙ=number average molecular weight; M_{w}=weight average molecular weight; pts=part(s) by weight; 1/s or sec⁻¹=reciprocal second(s) [s⁻¹]; ° C.=degree(s) Celsius; mmHg=millimeters of mercury; psi=pounds per square inch; kPa=kilopascal(s); %=percent; vol %=volume percent; mol %=mole percent; and wt. %=weight percent.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, and the like. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

The term “composition” refers to a mixture of materials which comprise the composition, as well as reaction products and decomposition products formed from the materials of the composition.

An “isocyanate” is a chemical that contains at least one isocyanate group in its structure. An isocyanate group is represented by the formula: —N═C═O or abbreviated as “NCO”. An isocyanate that contains more than one, or at least two, isocyanate groups is a “polyisocyanate.” An isocyanate that has two isocyanate groups is a diisocyanate and an isocyanate that has three isocyanate groups is a triisocyanate, etc. An isocyanate may be aromatic or aliphatic.

An “aromatic polyisocyanate” is a polyisocyanate comprising an isocyanate radical bonded to an aromatic radical and contains one or more aromatic rings.

An “aliphatic polyisocyanate” contains no isocyanate radical directly bonded to an aromatic ring or is better defined as an isocyanate which contains an isocyanate radical bonded to an aliphatic radical which can be bonded to other aliphatic groups, a cycloaliphatic radical or an aromatic ring (radical).

A “cycloaliphatic polyisocyanate” is a subset of aliphatic polyisocyanates, wherein the chemical chain is ring-structured.

A “polyether” is a compound containing two or more ether linkages in the same linear chain of atoms.

A “polyester” is a compound containing two or more ester linkages in the same linear chain of atoms.

A “polyol” is an organic compound containing multiple hydroxyl (OH) groups. In other words, a polyol contains at least two OH groups. Nonlimiting examples of suitable polyols include diols having two OH groups, triols having three OH groups, and tetraols having four OH groups.

A “polyester polyol” is a compound that contains a polyester and a hydroxyl functional group in the backbone structure of the compound.

A “polyether polyol” is a compound that contains a polyether and a hydroxyl functional group in the backbone structure of the compound.

As used herein, the term “hydroxyl functionality” refers to the number of isocyanate-reactive sites on a molecule. For polyols, an average hydroxyl functionality is generally the total moles of OH divided by the total moles of polyol.

A “film,” including when referring to a “film layer” in a thicker article, unless expressly having the thickness specified, includes any thin, flat extruded or cast thermoplastic article having a generally consistent and uniform thickness of about 0.5 millimeters (mm) (20 mils) or less in one dimension.

A “polymer film” is a film that is made of a polymer or a mixture of polymers. The composition of a polymer film is typically, 80 percent by weight (wt. %) of one or more polymers.

### Adhesive Composition

Generally, the two-component solventless adhesive compositions according to the present disclosure include (a) at least one isocyanate component and (b) at least one isocyanate-reactive component. The presently disclosed adhesive compositions can include: (a) an isocyanate component comprising an isocyanate-terminated polymer, and (b) an isocyanate-reactive component comprising a hydroxy-terminated resin compound. Optional additives, component (c), can also be mixed with components (a) and (b), if desired.

### The Isocyanate Component

The present disclosure is directed to two-component solventless polyurethane-based laminating adhesive compositions having improved chemical and thermal resistance, particularly when the two-component solventless polyurethane-based laminating adhesive composition is used in high-performance applications and/or when the two-component solventless polyurethane-based laminating adhesive composition is used to laminate one or more metal or metallized films.

The isocyanate component (a) of the solventless adhesive composition can comprise an isocyanate-terminated prepolymer. The isocyanate-terminated prepolymer can be the reaction product of a polyisocyanate and a polyol. In such a reaction, the polyisocyanate is present in excess in order to produce an isocyanate-terminated prepolymer.

Suitable polyisocyanates for use as component (a) according to the present disclosure can be selected from the group consisting of an aliphatic polyisocyanate, a cycloaliphatic polyisocyanate, an aromatic polyisocyanate, and combinations of two or more thereof. Suitable aromatic polyisocyanates useful in the present disclosure include, but are not limited to, for example 1,3- and 1,4-phenylene diisocyanate; 1,5-naphthylene diisocyanate; 2,6-toluene diisocyanate (“2,6-TDI”); 2,4-toluene diisocyanate (“2,4-TDI”); 2,4′-diphenylmethane diisocyanate (“2,4′-MDI”); 4,4′-diphenylmethane diisocyanate (“4,4′-MDI”); 3,3′-dimethyl-4,4′-biphenyldiisocyanate (“TODI”); and mixtures of two or more thereof. Suitable aliphatic polyisocyanates useful in the present disclosure include, but are not limited to, aliphatic polyisocyanates having from 3 carbon atoms to 16 carbon atoms; from 4 carbon atoms to 12 carbon atoms; and mixtures thereof. The carbon atoms of the aliphatic polyisocyanates can be located in the linear or the branched alkylene residue. The aliphatic polyisocyanates useful in the present disclosure include, but are not limited to, hexamethylene diisocyanate (“HDI”); 1,4-diisocyanatobutane; and mixtures thereof. Suitable cycloaliphatic polyisocyanates useful in the present disclosure include, but are not limited to, cycloaliphatic polyisocyanates having from 4 carbon atoms to 18 carbon atoms; cycloaliphatic polyisocyanates having from 6 to 15 carbon atoms; and mixtures thereof. The carbon atoms of the cycloaliphatic polyisocyanates can be located in the cycloalkylene residue. The cycloaliphatic diisocyanates of the present disclosure can include both cyclically and aliphatically bound NCO groups. The cycloaliphatic polyisocyanates useful in the present disclosure include, but are not limited to, for example, isophorone diisocyanate (“IPDI”); 1,3/1,4-diisocyanatocyclohexane 1,3-/1,4-bis(isocyanatomethyl)cyclohexane; diisocyanatodicyclohexylmethane (“H12MDI”); and mixtures thereof.

The suitable aliphatic and cycloaliphatic polyisocyanates useful in the present disclosure can further include, but are not limited to, for example, cyclohexane diisocyanate; methylcyclohexane diisocyanate; ethylcyclohexane diisocyanate; propylcyclohexane diisocyanate; methyldiethylcyclohexane diisocyanate; propane diisocyanate; butane diisocyanate; pentane diisocyanate; hexane diisocyanate; heptane diisocyanate; octane diisocyanate; nonane diisocyanate; nonane triisocyanate such as 4-isocyanatomethyl-1,8-octane diisocyanate (“TIN”); decane di- and triisocyanate; undecane di- and triisocyanate; and dodecane di- and triisocyanate; isophorone diisocyanate (“IPDI”); hexamethylene diisocyanate (“HDr”); diisocyanatodicyclohexylmethane (“H12MDI”); 2-methylpentane diisocyanate (“MPDI”); 2,2,4-trimethylhexamethylene diisocyanate/2,4,4-trimethylhexamethylene diisocyanate (“TMDI”); norbornane diisocyanate (“NBDI”); xylylene diisocyanate (“XDI”); tetramethylxylylene diisocyanate; and dimers, trimers; and mixtures of two or more thereof. Additional polyisocyanates suitable for use according to the present disclosure include, but are not limited to, for example 4-methyl-cyclohexane 1,3-diisocyanate; 2-butyl-2-ethylpentamethylene diisocyanate; 3(4)-isocyanatomethyl-1-methylcyclohexyl isocyanate; 2-isocyanatopropylcyclohexyl isocyanate; 2,4′-methylenebis(cyclohexyl) diisocyanate; 1,4-diisocyanato-4-methyl-pentane; and mixtures of two or more thereof.

The polyol, to be reacted with the polyisocyanate to form the isocyanate-terminated prepolymer, can comprise a polyol having a hydroxyl functionality of two or greater. The polyol can be selected from the group consisting of a polyester polyol, a polyether polyol, and mixtures thereof.

The isocyanate component (a) can have an NCO content of at least 3%, at least 6%, or at least 10%. The isocyanate component (a) can have an NCO content not to exceed 25%, not to exceed 18%, or not to exceed 14%. The isocyanate component (a) can have an NCO content of from 3% to 25%, from 6% to 18%, or from 10% to 14%. NCO content is determined according to ASTM D2572.

The isocyanate component (a) can have a viscosity value at 25° C. of from 300 npa-s to 40,000 mPa-s; from 500 mPa-s to 20,000 mPa-s; or from 1,000 mPa-s to 10,000 mPa-s as measured by the method of ASTM D2196.

The isocyanate component (a) can further comprise other constituents commonly known to those of ordinary skill in the art.

### The Isocyanate-Reactive Component

The two-component solventless adhesive composition of the present disclosure further comprises at least one isocyanate-reactive component (b). The isocyanate-reactive component (b) includes an isocyanate-reactive group that reacts with the isocyanate group of the isocyanate component (a) to generate a cross-linked polymer network. Component (b) can include, for example, a mixture of: (bi) at least one hydroxy-terminated polyurethane resin; (bii) at least one polyether polyol; (biii) at least one phosphate ester adhesion promoter; and (biv) optionally, at least one bio-based polyol.

### The Polyether Polyol

The polyether polyol, component (bii), of the isocyanate-reactive component can include one or more resin components. The polyether polyol useful for forming the isocyanate-reactive component (b), according to the present disclosure can include, but are not limited to, polyether polyols having a hydroxy functionality of two or more (e.g., di-functional, tri-functional, and so on). The polyether polyol can have a hydroxyl number from 100 mg KOH/g to 400 mg KOH/g measured according to ASTM D4274. The polyether polyol can have a number average molecular weight of, for example, from 100 to 3,000; from 200 to 2,500; or from 350 to 2,000. The polyether polyol can have a viscosity at 25° C. of, for example, from 50 cps to 1,000 cps measured according to ASTM D4878.

Commercially available examples of polyether polyols suitable for forming the isocyanate-reactive component (b) according to the present disclosure, include for example, but are not limited to, products sold under the trade names VORANOL™ CP-450, VORANOL™ 220-260, and VORANOL™ 220-110N, each available from The Dow Chemical Company.

The polyether polyol can further comprise, for example, a triol with a weight average molecular weight of less than 300. Commercially available examples of the triol suitable for forming the isocyanate-reactive component (b) according to the present disclosure, include but are not limited to, trimethylolpropane (“TMP”) available from Sigma-Aldrich.

The amount of the polyether polyol in the isocyanate-reactive component (b) can be, for example, from 4 wt. % to 60 wt. % based on the weight of the isocyanate-reactive component or from 6 wt. % to 50 wt. % in based on the weight of the isocyanate-reactive component.

### The Phosphate Ester Adhesion Promoter

The phosphate ester adhesion promoter, component (biii), of the isocyanate-reactive component can include one or more resin components. For example, the phosphate ester adhesion promoter useful for forming the isocyanate-reactive component (b), according to the present disclosure can include, but are not limited to, a phosphate ester-based polyol. The phosphate ester-based polyol useful in the present disclosure can be made from a mixture comprising; a tri-functional or di-functional propylene glycol; and a polyphosphoric acid such as phosphonopentanoic acid. The phosphate ester-based polyol can have a phosphoric acid content of, for example, less than 4 weight percent based on the weight of the phosphate ester polyol; a phosphoric acid content of from 0.1 to 3 weight percent based on the weight of the phosphate ester polyol; or a phosphoric acid content of from 1.5 to 2.5 weight percent based on the weight of the phosphate ester polyol. The phosphate ester-based polyol can have a viscosity of, for example, less than 40,000 cps at 25° C.; or less than 30,000 cps at 25° C., as measured by the method of ASTM D2196.

The amount of the phosphate ester adhesion promoter in the isocyanate-reactive component (b) can be, for example, from 0.5 wt. % to 15 wt. % based on the weight of the isocyanate-reactive component; or from 1 wt. % to 5 wt. %, based on the weight of the isocyanate-reactive component. One example of a technique for preparing a suitable phosphate ester adhesion promoter is provided in the Examples described herein below.

### The Optional Bio-Based Polyol

The bio-based polyol, component (bio), of the isocyanate-reactive component can include one or more additive components. The bio-based polyol useful for forming the isocyanate-reactive component (b), according to the present disclosure can include, but are not limited to, castor oil, other naturally-derived oils, or combinations of two or more of such oils.

Commercially available examples of castor oil suitable for forming the isocyanate-reactive component (b) according to the present disclosure, include but are not limited to, urethane grade castor oil available from Campbell & Co.

The amount of the bio-based polyol, component (biv), in the isocyanate-reactive component can be, for example, from 0 wt. % to 50 wt. % based on the weight of the isocyanate-reactive component, from 0.1 wt. % to 50 wt. % based on the weight of the isocyanate-reactive component, or from 15 wt. % to 30 wt. % based on the weight of the isocyanate-reactive component.

The mole ratio of NCO groups presents in the isocyanate component (a) to the OH groups present in the isocyanate-reactive component (b) can be, for example, from 0.8 to 1.7; from 1.0 to 1.6; or from 1.2 to 1.5. The mix ratio, by weight, for the isocyanate component and isocyanate-reactive component can be determined based upon the desired ratio of NCO groups to OH groups. The mix ratio, by weight, of the isocyanate component (a) to the isocyanate-reactive component (b) in the final solventless adhesive composition of the present disclosure can be, for example, from 100:40 to 100:80, or from 100:50 to 100:70.

The two-component solventless adhesive composition of the present disclosure exhibits several advantageous properties and/or benefits including, for example increased adhesion to metalized films.

For example, the improvement property of increased adhesion exhibited by the adhesive compositions of the present disclosure can be from 600 gm/inch to 1700 gm/inch, or from 700 gm/inch to 1500 gm/inch. The method of measuring increased adhesion is described in testing section below

### Adhesive Composition Production

It is contemplated that two components, an isocyanate component and a polyol component, are employed in the present disclosure. It is also contemplated that the isocyanate component and the polyol component of the disclosed adhesive composition can be made separately and, if desired, stored until it is desired to use the adhesive composition. The process of producing the adhesive composition includes mixing the isocyanate and polyol components described above to form an adhesive composition. Both the isocyanate component and the polyol component can each be liquid at 25° C. When it is desired to use the adhesive composition, the isocyanate component and the polyol component are brought into contact with each other and mixed together, typically at a stoichiometric ratio (NCO/OH) between 1 and 1.7.

To form the adhesive composition, mixing of the two components may take place at any suitable time in the process of forming the adhesive composition and applying the adhesive to a substrate, such as before, during, or as a result of the application process. All of the present steps may be carried out under ambient, room temperature conditions. As desired, heating or cooling may be employed. The mixing can be carried out using a suitable conventional mixer, such as using an electrically, pneumatically, or an otherwise powered mechanical mixer.

The process for preparing the adhesive composition of the present disclosure includes, for example, the steps of (1) providing the isocyanate component; (2) providing the polyol component; and (3) mixing the two components to form a resin mixture.

### Fabricating a Laminate Using The Adhesive Composition

A laminate comprising the solventless adhesive compositions of the present disclosure can be formed by a process including the steps of: (I) forming a two-component solventless adhesive composition of the present disclosure by mixing the at least one isocyanate adhesive component (a) with the at least one isocyanate-reactive adhesive component (b); and (II) applying the mixed adhesive composition of step (I) to a film.

The process of forming the laminate comprising the solventless adhesive compositions of the present disclosure can be formed by a process including the steps of:
(I) forming a two-component solventless adhesive composition of the present disclosure by mixing the at least one isocyanate adhesive component (a) with the at least one isocyanate-reactive adhesive component (b);
(II) applying the mixed adhesive composition of step (I) to at least a portion of a surface of a first substrate; and
(III) bringing a surface of a second substrate into contact with the adhesive composition of step (II) located on the surface of the first substrate for bonding the first substrate to the second substrate thereby forming the laminate structure.

A layer of the mixed solventless adhesive composition of the present disclosure can be applied to a surface of a first substrate. The surface of the first substrate comprising the mixed adhesive composition can be brought into contact with a surface of the second substrate, and then the two substrates can be run through a device for applying external pressure to the first and second substrates, such as nip roller. Arrangements of such rollers in an application apparatus are commonly known in the art. The mixed adhesive composition is then cured or allowed to cure at any temperature such as from room temperature (i.e., approximately 25° C.) up to 50° C. or higher. The coating weight of the applied adhesives to the film substrates can be from 1.2 g/m² to 3.5 g/m², or from 1.6 g/m² to 3.0 g/m².

Suitable the first and the second substrates useful for fabricating the laminate structures of the present disclosure include films such as paper, woven and nonwoven fabric, metal foil, polymer films, metal-coated polymer films, and combinations of two or three or multilayers. Some films optionally have a surface on which an image is printed with ink which may be in contact with the adhesive composition. The substrates are layered to form a laminate structure, with an adhesive composition of the present disclosure adhering one or more of the substrates together.

The laminate, made using the two-component solventless adhesive composition of the present disclosure, and fabricated with the process described above, exhibits several advantageous properties and/or benefits including, for example, improved boil-in-bag, chemical aging, retort performance, and/or metalized film adhesion compared to existing laminates made with conventional solventless adhesives of the prior art. The adhesive compositions and laminates of the present disclosure having improved chemical and thermal resistance performance properties are particularly beneficial when the adhesive compositions and laminates are used in high-performance applications; and/or, when the adhesive compositions are used to laminate one or more metal or metallized films together.

For example, the boil-in bag improvement property exhibited by the laminates of the present disclosure can be from 500 gm/inch to 1500 gm/inch, from 550 gm/inch to 1400 gm/inch, or from 600 gm/inch to 1300 gm/inch. The method of measuring chemical resistance is described in testing methods section below.

For example, the chemical aging improvement property exhibited by the laminates of the present disclosure can be from 200 gm/inch to 1500 gm/inch, from 300 gm/inch to 1400 gm/inch, or from 400 gm/inch to 1200 gm/inch. The method of measuring chemical resistance is described in testing methods section below.

For example, the retort improvement property exhibited by the laminates of the present disclosure can be from 400 gm/inch to 1400 gm/inch, from 800 gm/inch to 1000 gm/inch, or from 500 gm/inch to 1000 gm/inch. The method of measuring retort is described in testing methods section below.

### Testing Methods

### Heat Sealing

A laminate sample is heat sealed using a SENCORP™ 12ASL/1 heat sealer at 350° F. for 1 s. After heat sealing, the heat-sealed sample is cut into three 2.54 cm wide strips for testing the heat-sealed samples using the T-peel bond strength test described below.

### Bond Strength Measurement

The bond strength of a laminate sample is measured using a 90° T-peel test. The 90° T-peel test is measured on laminate samples cut to 1-inch (2.54-cm) wide strips and pulled on a Thwing Albert™ QC-3A peel tester equipped with a 50N loading cell at a rate of 10 in/min. When the two films comprising the laminate sample separate (peel), the average of the force during the pull is recorded. If one of the films stretch or break, the maximum force or force at break is recorded. The values recorded are the average of the three separate sample strips. The failure mode (FM) or mode of failure (MOF) is also recorded in accordance with one or more of the following acronyms:
“FS” which stands for “film stretch”;
“FT” which stands for “film tears” (or breaks);
“DL” which stands for “delaminated” or “delamination”, wherein the secondary film separated from the primary film;
“AT” which stands for “adhesive transfer”, wherein the adhesive fails to adhere to the primary film and the adhesive is transferred to the secondary film; and
“AS” which stands for “adhesive split” (or cohesive failure), wherein the adhesive is found on both the primary film and the secondary film.

### Boil-in-Bag Test Procedure

Boil-in-bag testing is performed on pouches made from laminate sample structures. Laminates are first made from the Prelam Al/GF-19 or the Prelam/CPP film structures as described above. One of the 9 inches×12 inches (23 cm×30.5 cm) sheets of a cured laminate structure is folded over to form a double layer such that the polymer film of one layer is in contact with the polymer film of the other layer. The double layer when folded is about 9 inches×6 inches (23 cm×15.3 cm). The edges of the double layer are then trimmed using a paper cutter to obtain a folded piece about 5 inches×7 inches (12.7×17.8 cm). The edges of the folded piece (two long sides and one short side) are heat sealed at the edges to form a pouch with an interior size of 4 inches×6 inches (10.2 cm×15.2 cm). The heat sealing is done at 350° F. (177° C.) for 1 second at a hydraulic pressure of 40 psi (276 kPa). Two or three pouch samples are made for each test.

Before testing, the sample pouches are filled, through the open top edge of the pouches, with 100 mL±5 mL of 1:1:1 sauce (a blend of equal parts by weight of ketchup, vinegar and vegetable oil). Splashing the filling onto the heat seal area is avoided as this could cause the heat seal to fail during the test. After filling a sample pouch with sauce, the open top edge of the pouch is sealed in a manner that minimizes air entrapment inside of the pouch to form a completely sealed pouch (bag). The seal integrity is inspected on all four sides of the pouch to ensure that there are no flaws in the sealing that would cause the pouch to leak during the test. Any defective pouches are discarded and replaced. In some instances, flaws in the laminate are marked to identify whether new additional flaws are generated during the testing of the pouches.

A pot is filled ⅔ full of water and brought to a rolling boil. The filled pouches are then carefully placed in the boiling water and kept immersed in the boiling water for 30 min. The boiling pot is covered with a lid to minimize water and steam loss. The pot is observed during the test to ensure that there is enough water present to maintain boiling. After 30 min in the boiling water, the pouches are removed from the pot of boiling water; and the extent of tunneling, blistering, de-lamination, or leakage is compared with any of the marked preexisting flaws in the pouch. The observations are recorded. The pouches are cut open, emptied, and rinsed with soap and water. At least three one-inch (2.54-cm) strips are cut from the pouches and the T-peel bond strength of the strips is measured at 10 inch/min according to the above-described T-peel bond strength test. The T-peel bond strength is done as soon as possible after removing the pouch contents. The interior of the empty pouches is then examined and any other visual defects are recorded.

### Chemical Aging Test Procedure

Laminates are made from the Prelam Al/GF-19, or Prelam/CPP as described below. One of the 9 inches×12 inches (23 cm×30.5 cm) sheets of laminate are folded over to give a double layer about 9 inches×6 inches (23 cm×15.3 cm) such that the polymer film of one layer is in contact with the polymer film of the other layer. The edges are trimmed on a paper cutter to give a folded piece about 5 inches×7 inches (12.7×17.8 cm). Two long sides and one short side are heat sealed at the edges to give a finished pouch with an interior size of 4 inches×6 inches (10.2 cm×15.2 cm). The heat sealing is done at 350° F. (177° C.) for 1 second at a hydraulic pressure of 40 PSI (276 kPa). Two or three pouches are made for each test.

The pouches are filled through the open edge with 100±5 mL of 1:1:1 sauce (blend of equal parts by weight of ketchup, vinegar and vegetable oil). Splashing the filling onto the heat seal area is avoided as this could cause the heat seal to fail during the test. After filling the pouches with sauce, the top of the pouch is sealed in a manner that minimizes air entrapment inside of the pouch. The seal integrity is inspected on all four sides of the pouches to ensure that there are no flaws in the sealing that would cause the pouch to leak during the test. Any defective pouches are discarded and replaced. In some instances, flaws in the laminate are marked prior to testing to identify whether new additional flaws are generated during the testing.

The pouches containing the 1:1:1 sauce are then placed in a convection oven set at 60° C. for 100 hr. The pouches are then removed after aging and the extent of tunneling, blistering, de-lamination, or leakage is compared with any of the marked preexisting flaws. The observations are recorded. The pouches are cut open, emptied, and rinsed with soap and water. One or more one-inch (2.54-cm) strips are cut from the pouches and the laminate bond strength is measured according to the standard bond strength test described earlier. This is done as soon as possible after removing the pouch contents. The interior of the pouches are examined and any other visual defects are recorded.

### Retort Test Procedure

Laminates are made from the Prelam/CPP as described below. One of the 9 inches×12 inches (23 cm×30.5 cm) sheets of laminate is folded over to give a double layer about 9 inches×6 inches (23 cm×15.3 cm) such that the CPP film of one layer is in contact with the CPP film of the other layer. The edges are trimmed on a paper cutter to give a folded piece about 5 inches×7 inches (12.7×17.8 cm). Two long sides and one short side are heat sealed at the edges to give a finished pouch with an interior size of 4 inches×6 inches (10.2 cm×15.2 cm). The heat sealing is done at 400° F. (204° C.) for 1 s at a hydraulic pressure of 40 psi (276 kPa). Two or three pouches are made for each test.

Pouches are filled through the open edge with 100±5 mL of distilled water (DI water) or 3% (by volume) acetic acid aqueous solution. Splashing the filling onto the heat seal area is avoided as this could cause the heat seal to fail during the test. After filling, the top of the pouch is sealed in a manner that minimizes air entrapment inside of the pouch. The seal integrity is inspected on all four sides of the pouches to ensure that there are no flaws in the sealing that would cause the pouch to leak during the test. Any defective pouches are discarded and replaced. In some instances, flaws in the laminate are marked prior to testing to identify whether new additional flaws are generated during the testing.

The pouches containing the DI water or 3% acetic acid solution are then placed in a STERIS autoclave set at 121° C. for 1 hr. The pouches are removed after retort and the extent of tunneling, blistering, de-lamination, or leakage is compared with any of the marked pre-existing flaws. The observations are recorded. The pouches are cut open, emptied, and rinsed with soap and water. One or more one-inch (2.54-cm) strips are cut from the pouches and the laminate bond strength is measured according to the standard bond strength test described earlier. This was done as soon as possible after removing the pouch contents. The interior of the pouches is examined and any other visual defects are recorded.

### EXAMPLES

The present disclosure will now be explained in further detail by describing examples illustrating the adhesive compositions of the present disclosure and laminates formed therefrom. The following Inventive Examples (Inv. Ex.) and Comparative Examples (Comp. Ex.) (collectively, “the Examples”) are presented herein to further illustrate the features of the present disclosure but are not intended to be construed, either explicitly or by implication, as limiting the scope of the claims. The Inventive Examples of the present disclosure are identified by Arabic numerals and the Comparative Examples are represented by letters of the alphabet. The adhesive compositions and laminates prepared therefrom will be better understood by reference to the following Examples, which are offered by way of illustration and which one skilled in the adhesive art and technologies of adhesive compositions and laminates will recognize are not meant to be limiting. Unless otherwise stated all parts and percentages are by weight on a total weight basis.

### Raw Materials

Pertinent raw materials used in the Examples are described in Table I.

TABLE I
Raw Materials

| Material | Brief Description | Supplier |
|---|---|---|
| MOR-FREE ™ | Isocyanate-terminated | Dow Inc |
| L75-191 | polyurethane prepolymer | |
| MOR-FREE ™ | Isocyanate-terminated | Dow Inc |
| L75-164 | polyurethane prepolymer | |
| MOR-FREE ™ C-411 | Polyester/polyether polyol blend | Dow Inc |
| MOR-FREE ™ C-117 | Polyol based on polyester | Dow Inc |
| MOR-FREE ™ C-79 | Polyol based on polyether-castor | Dow Inc |
| | oil blend | |
| MOR-FREE ™ | Isocyanate prepolymer based | Dow Inc |
| L75-100 | on polyester-polyether blend | |
| | reacted with Isocyanate | |
| MOR-FREE ™ 990 | Isocyanate prepolymer based | Dow Inc |
| | on polyester and polymer | |
| | blend reacted with | |
| | MDI isocyanate | |
| MOR-FREE ™ | Polyol based on polyester | Dow Inc |
| L82-105 | | |
| MOR-FREE ™ C-33 | poly Aliphatic isocyanate | Dow Inc |
| MOR-FREE ™ | Solvent-free phosphate ester | Dow Inc |
| 88-138 | adhesion promoter | |
| PacAcel ™ CR-85 | Polyol based on polyether-castor | Dow Inc |
| | oil blend | |
| MOR-FREE ™ | Polyol based on polyester-castor | Dow Inc |
| CR-96 | oil-polyetherblend | |
| Polyphosphoric acid | 115 grade, pure, >84% | Sigma Aldrich |
| | phosphate (as P₂O₅) | |
| Glycerol phosphate | Glycerol phosphate | Sigma Aldrich |
| disodium salt | disodium salt | |
| Glycerol | triol | Sigma Aldrich |
| Phosphoric acid | Orthophosphoric Acid | Sigma Aldrich |
| Phosphonohexanoic | 6-Phosphonohexanoic acid | Sigma Aldrich |
| acid | | |
| Prelam film | A prelaminated (“Prelam”) | American |
| (Polyester film | composite film comprising (1) a | Packaging |
| laminated with | polyethylene terephthalate (PET) | Company |
| Aluminum | film having thickness of 12 | |
| foil) | μm and (2) an aluminum foil | |
| | (e.g., a soft lamination grade | |
| | AMCOR ™ aluminum foil) | |
| | having thickness of 9 μm | |
| | laminated together with an | |
| | adhesive formulation (e.g., | |
| | ADCOTE ™ | |
| | 550/COREACTANT F). | |
| 3 mil CPP film | Cast polypropylene (CPP) | Berry Plastics |
| | film 76 μm thickness | XCPP-440 |
| GF-19 polyethylene | High slip, low density | Berry Plastics |
| film | polyethylene film, | Corp. |
| | thickness = 1.5 mil | |

### General Procedure for Lamination

Polyol co-reactant and isocyanate prepolymer are mixed in the ratios specified in the Examples to form a reactive adhesive mixture. The resultant adhesive mixture is applied to a primary film, followed by laminating the primary film with a secondary film to form a composite laminate film structure in a lamination equipment system. The laminate composite film structures are prepared using a Nordmeccanica Labo-combi pilot laminator with a nip temperature set to 120° F. and a line speed set to 100 feet/min.

A coating weight for the laminates is adjusted to be about 1.6 g/m² to 1.9 g/m². Around 100 feet of each laminate is prepared for each formulation with some bond strips inserted to facilitate bond testing. The formed laminate structures are allowed to cure at room temperature for 1 week. Using the test methods and procedures described below, various laminate film composite structures are evaluated, including for example, the following film structures: 48-LBT/GF-19; NYLON/GF-10; and 48 gLBT/Met-PET.

The bond strength between the primary film and the secondary film are measured at various intervals after the above lamination procedure. The laminate composite film structures are stored at room temperature for 7 days; and after 7 days, pouches are made using the laminate composite film structure. The pouches are filled with a 1:1:1 sauce blend of equal parts by weight of ketchup, vinegar and vegetable oil. Then, the filled pouches are subjected to various tests including, for example, one or more of the following tests: (1) 1-day bond strength, (2) 7-day bond strength, (3) boil-in-bag, (4) chemical aging, and (5) retort; and the tests results are described in the Examples.

### Synthesis Example 1—Synthesis of Glycerol Phosphate Using Ion Exchange

In Synthesis Example 1, glycerol phosphate is prepared by conducting ion exchange on glycerol phosphate disodium salt. The ion exchange resin is DowEx 50WX8 (available from The Dow Inc). The glycerol phosphate disodium salt (available from Sigma Aldrich) is added to deionized (DI) water to obtain a 10 wt. % solution. The ion exchange resin (approximately five times the weight of glycerol phosphate disodium salt) is added to the glycerol phosphate disodium salt/DI water solution; and the resultant solution is stirred for a few days or longer. The solution is then filtered through a 5-micron nylon syringe filter. Water is evaporated from the solution by drying the solution in a Petri dish in a fume hood; and then, water is further evaporated from the solution by drying the solution in a vacuum oven at 50° C. overnight. Glycerol phosphate in the form of a viscous liquid is obtained at the end of the above process.

### Examples 1(a)-(f) and Comparative Example A (Control)—Adhesive

The glycerol phosphate obtained as described in Synthesis Example 1 above is added to a polyol, Mor-Free™ C-411 polyol, in the various amounts described in Table A. The glycerol phosphate and Mor-Free™ C-411 polyol components, described in Table A, are mixed together using a Flacktek high speed mixer at a speed of 2,000 rpm for 2 min to form a polyol mixture (also referred to as a polyol blend or isocyanate-reactive component).

TABLE A

| | MOR-FREE ™ | Glycerol |
|---|---|---|
| | C-411 | Phosphate |
| Example No. | (g) | (g) |
| Control (Comparative | 50.00 | 0.00 |
| Example A) | | |
| Example 1(a) | 49.90 | 0.10 |
| Example 1(b) | 49.57 | 0.22 |
| Example 1(c) | 49.65 | 0.35 |
| Example 1(d) | 49.50 | 0.50 |
| Example 1(e) | 49.12 | 0.88 |
| Example 1(f) | 48.68 | 1.32 |

Then, 40 parts of the Control consisting of only Mor-Free™ C-411 and each of the polyol bends (glycerol phosphate/Mor-Free™ C-411) described in Table A is mixed with 100 parts of Mor-Free™ L75-164 isocyanate prepolymer to form a reactive adhesive mixture.

### Examples 2(a)-(f) and Comparative Example B (Control)—Laminate (Prelam/GF-19 Film)

Each of the adhesive mixtures prepared as described above in Examples 1(a)-1(f) and Comparative Example A (Control); and based on Table A are applied on a Prelam film with a coat weight of 1.07 lbs/ream, followed by laminating the coated Prelam film with GF-19 film using a Nordmeccanica LaboCombi laminator, to form sample laminates to be tested.

Each of the laminates prepared as described above are tested in accordance with the following tests: (1) bond strength after one day, (2) bond strength after seven days, (3) boil in bag, and (4) chemical aging. The results of testing the laminates are described in the Table 1. From the results in Table 1, it can be concluded that the bond strength after the boil in bag test can be improved significantly with the use of the glycerol phosphate additive. The Control laminate (Comparative Example B) using an adhesive without the glycerol phosphate additive has negligible bond strength after the boil in bag test, whereas the laminate samples using an adhesive with the glycerol phosphate additive have significant bond strength. In addition, the bond strength after the chemical aging test also improved significantly using an adhesive with the glycerol phosphate additive.

### Examples 3(a)-(f) and Comparative Example C (Control)—Laminate (Prelam/CPP Film)

Each of the adhesive mixtures prepared as described above in Examples 2(a)-(f) and Comparative Example A (Control); and based on Table A are applied on a Prelam film with a coat weight of 1.05 lbs/ream, followed by laminating the coated Prelam film with 3-mil CPP film using the same Labocombi laminator as used in the above Examples, to form sample laminates to be tested. Each of the laminate samples prepared as described above was tested in accordance with the following tests: (1) bond strength after seven days, (2) boil in bag, (3) chemical aging, and (4) retort. The results of testing the laminates are described in the Table 2. From the results in Table 2, it can be concluded that the bond strength after boil in bag test, the chemical aging test, and the retort test of the laminates improved significantly with the addition of glycerol phosphate additive to the adhesive formulation.

### Comparative Examples D and E—The Adhesive

Polyphosphoric acid is mixed with Mor-Free™ C-411 polyol as described in the Table B to form a polyol and polyphosphoric acid component blend. The amount of polyphosphoric acid in the blends of Comparative Example D) and Comparative Example E are calculated to keep the phosphorous element at a level the same as in Examples 2(b) and 2(e), respectively.

TABLE B

| | C-411 | Polyphosphoric Acid |
|---|---|---|
| Example No. | (gm) | (gm) |
| Comparative Example D | 49.79 | 0.115 |
| Comparative Example E | 49.6 | 0.45 |

In this Example, 40 parts of each of the blends of Mor-Free™ C-411 and polyphosphoric acid described in Table B are mixed with 100 parts of Mor-Free L75-164 to form a reactive adhesive mixture.

### Comparative Examples F and F— The Laminate (Prelam/GF-19 Film)

Sample laminates based on each of the adhesive mixtures based on Table B are prepared on Prelam/GF19 structure using the same procedure as described in Example 2 above. Each of the laminates are subjected to 1-day bond, 7-day bond, boil in bag and chemical aging testing. The test results are described in Table 1. From the results in Table 1, it can be seen that the bond strength after the boil in bag and chemical aging test with the polyphosphoric acid is much less compared to values obtained in Example 2.

### Comparative Example G—The Adhesive

In Comparative Example G, 20.1 g of Mor Free 88-138 polyol containing a phosphate ester is added to 22.3 g of Mor-Free™ C-411 polyol. The resultant polyol blend is mixed using the Flacktek high speed mixer and conditions as described in Example 2 above. The amount of Mor-Free™ 88-138 polyol used in this Comparative Example is calculated to keep the phosphorous element level at the same level as the level in Example 2(e). Then, 42 parts of the Mor Free 88-138 polyol containing a phosphate ester and Mor-Free™ C-411 polyol blend is mixed with 97 parts of Mor-Free L75-164 isocyanate to form a reactive adhesive mixture.

### Comparative Example H—The Laminate (Prelam/GF-19 Film)

In Comparative Example H and using the adhesives prepared above in Comparative Example G, sample laminates are prepared on Prelam/GF19 films as described in Example 2 above. The sample laminates are subjected to the 1-day bond strength test, the 7-day bond strength test, the boil in bag test and the chemical aging test. The test results are described in Table 1. From the test results in Table 1, it can be concluded that the bond strength, after the boil in bag and chemical aging tests, of the laminates with the adhesive formulation described above in Comparative Example G are much less compared to the values obtained in Examples 2 (a)-(f).

### Comparative Example I—Example from WO 2015/168670

WO2015/168670 discloses the synthesis of glycerol phosphate additive by reacting polyphosphoric acid with glycerin and using the resultant synthesized glycerol phosphate additive in a solvent-based adhesive formulation consisting of ADCOTE™ 795 polyol and an isocyanate functional pre-polymer in ethyl acetate as the solvent. As disclosed in WO2015/168670, a control adhesive formulation sample without the above glycerol phosphate additive has a bond strength of 282 g/inch after the boil in bag test, whereas an adhesive formulation with the above glycerol phosphate additive, the bond strength after boil in bag is 471 g/inch. Hence, the adhesive formulation disclosed in WO 2015/168 provides an improvement compared to the control adhesive formulation mentioned in WO 2015/168. However, the adhesive formulation of the present disclosure provides a significant improvement in bond strength after the boil in bag test compared to the control adhesive formulation mentioned in WO2015/168. In addition, the bond strength after the boil in bag test for the adhesive formulation of the present disclosure is significantly increased or maintained at a comparable level when compared to the adhesive formulation of WO2015/168670.

### Examples 4(a) and 4(b) and Comparative Example J (Control)—Glycerol Phosphate in Mor-Free™ CR-96+Mor-Free™ 990—The Adhesive

In this Example, the glycerol phosphate described in Synthesis Example 1 is added to a polyol, Mor-Free™ CR-96 polyol, in the various amounts described in Table C. The resultant blends of glycerol phosphate and Mor-Free™ CR-96 polyol are mixed using a Flacktek high speed mixer at a speed of 2,000 rpm for 2 min to form the polyol blends.

TABLE C

| | Mor-Free ™ | Glycerol |
|---|---|---|
| | CR-96 | Phosphate |
| Example No. | (g) | (g) |
| Control (Comparative Example J) | 100.00 | 0.00 |
| Example 4(a) | 99.75 | 0.25 |
| Example 4(b) | 98.90 | 1.10 |

Then, 82 parts of the Control (Comparative Example J) consisting of only Mor-Free™ CR-96 and each of the glycerol phosphate/Mor-Free™ CR-96 polyol blends is mixed with 100 parts of Mor-Free™ 990 isocyanate prepolymer to form a reactive adhesive mixture.

### Example 5 and Comparative Example K (Control)—Glycerol Phosphate in Mor-Free™ CR-96+Mor-Free™ 990—The Laminate (Prelam/GF-19 Film)

Each of the resultant adhesive mixtures produced above based on Table C is applied on a Prelam film with a coat weight of 1.74 lbs/ream, followed by laminating the coated Prelam film with a GF-19 film with a Nordmeccanica LaboCombi laminator to form sample laminates for testing. Each of the prepared sample laminates is then subjected to the 1 day bond strength test, the 7 day bond strength test, the boil in bag test and the chemical aging test. The results of the tests are described in Table 1.

### Example 6 and Comparative Example L (Control)—Glycerol Phosphate in Mor-Free™ CR-96+Mor-Free™ 990—The Laminate (Prelam/CPP Film)

Each of the resultant adhesive mixtures produced above based on Table C is applied on a Prelam film with a coat weight of 1.74 lbs/ream, followed by laminating the coated Prelam film with a 3-mil CPP film with the same laminator used in Example 5 above to form sample laminates for testing. Each of the prepared sample laminates is then subjected to the 1-day bond strength test, the 7-day bond strength test, the boil in bag test and the chemical aging test. The results of the tests are described in Table 2.

It should be noted that Mor-Free™ CR-96+Mor-Free™ 990 adhesive already contains a phosphate ester adhesion promoter. However, as described in Table 2, the boil in bag, the chemical aging and the retort performance of the Mor-Free™ CR-96+Mor-Free™ 990 adhesive system was improved further by adding a glycerol phosphate additive.

### Example 7-6-Phosphonohexanoic Acid in Mor-Free™ C-411+Mor-Free™ L75-164—The Adhesive

In Example 7, 0.88 g of 6-phosphonohexanoic acid is mixed with 49.12 g of Mor-Free™ C-411 polyol. The 6-phosphonohexanoic acid/Mor-Free™ C-411 polyol blend of 6-phosphonohexanoic acid and Mor-Free™ C-411 polyol is mixed using a Flacktek high speed mixer at a speed of 2,000 rpm for 2 min. Then, 40 parts of the 6-phosphonohexanoic acid/Mor-Free™ C-411 polyol blend is mixed with 100 parts of Mor-Free™ L75-164 isocyanate prepolymer to form an adhesive mixture.

### Example 8-6-Phosphonohexanoic Acid in Mor-Free™ C-411+Mor-Free™ L75-164—The Laminate (Prelam/GF-19 Film)

The adhesive mixture prepared in Example 7 above is applied on a Prelam film with a coat weight of 1.07 lbs/ream, followed by laminating the coated Prelam film with a GF-19 film with a Nordmeccanica LaboCombi laminator to form sample laminates for testing. The prepared sample laminates are then subjected to the 1-day bond strength test, the 7-day bond strength test, the boil in bag test, and the chemical aging test. The test results are described in the Table 1. From the results in Table 1, it can be concluded that the bond strength, after the boil in bag testing and the chemical aging testing, can be improved significantly by using the 6-phosphonohexanoic acid as an additive in the adhesive formulation.

TABLE 1
Performances for Prelam//GF19 Laminate Structures

| | | | | | Boil in Bag | | Chemical Aging | |
|---|---|---|---|---|---|---|---|---|
| | 1-Day Bond | | 7-Day Bond | | (1:1:1) | | (1:1:1) | |
| Example | T-Peel | | T-Peel | | T-Peel | | T-Peel | |
| No. | (g/2.54 cm) | FM | (g/2.54 cm) | FM | (g/2.54 cm) | FM | (g/2.54 cm) | FM |
| Control (Comparative | 557 | AT | 572 | AT | 75 | AT | 31 | AS, |
| Example A) | | | | | | | | tunnel |
| (Mor-Free ™ C-411 + | | | | | | | | |
| Mor-Free ™ L75-164) | | | | | | | | |
| Example 1 (a) | 864 | AT | 743 | AT | 769 | AT | 85 | AS |
| Example 1 (b) | 695 | AT | 783 | AT | 719 | AT | 269 | AS |
| Example 1 (c) | 941 | AT | 828 | AT | 997 | AT | 224 | AS |
| Example 1 (d) | 849 | AT | 856 | AT | 933 | FS/AT | 281 | AS |
| Example 1 (e) | 605 | AT | 595 | AT | 674 | AT | 615 | AS |
| Example 1 (f) | 702 | AT | 553 | AT | 680 | AS/AT | 530 | AS |
| Comparative | 762 | AT | 804 | AT | 485 | AT | 44 | AS |
| Example B | | | | | | | | |
| Comparative | 805 | AT | 692 | AT | 432 | AT | 124 | AS |
| Example C | | | | | | | | |
| Comparative | 1336 | FT | 801 | AT | 507 | AT | 399 | AT |
| Example D | | | | | | | | |
| Control (Comparative | 537 | AT | 466 | AT | 349 | AT/AS | 141 | AS |
| Example E) | | | | | | | | |
| (Mor-Free ™ CR-96 + | | | | | | | | |
| Mor-Free ™ 990 | | | | | | | | |
| Example 2 (a) | 552 | AT | 50 | AT | 456 | AT | 341 | AS |
| Example 2 (b) | 610 | AT | 537 | AS | 620 | AT | 222 | AT |
| Example 3 | 777 | AT | 464 | AT | 617 | AS | 792 | AT/FS |

TABLE 2
Performance for Prelam//CPP Laminate Structures

| | | | | | | | | | Retort | |
|---|---|---|---|---|---|---|---|---|---|---|
| | | | Boil in Bag | | Chemical Aging | | Retort | | (3 vol. % | |
| | 7-Day Bond | | (1:1:1) | | (1:1:1) | | (DI Water) | | Acetic Acid) | |
| Example | T-Peel | | T-Peel | | T-Peel | | T-Peel | | T-Peel | |
| No. | (g/2.54 cm) | FM | (g/2.54 cm) | FM | (g/2.54 cm) | FM | (g/2.54 cm) | FM | (g/2.54 cm) | FM |
| Control (Comparative | 763 | AT | 154 | AT | 36 | AS | Complete | | | |
| Example C) | | | | | | | delam* | | | |
| (Mor-Free ™ C-411 + | | | | | | | | | | |
| Mor-Free ™ L75-164) | | | | | | | | | | |
| Example 2(e) | 990 | AT/AS | 957 | AT | 410 | AS | 588 | AS | 579 | AS |
| Example 2(f) | 957 | AT/AS | 910 | AT | 571 | AS | 752 | AS | 704; AS | AS |
| Control (Comparative | 221 | AS | 221 | AS | 174 | AS | 285 | AS | 203 | AT |
| Example L) | | | | | | | | | | |
| (Mor-Free ™ CR-96 + | | | | | | | | | | |
| Mor-Free ™ 990) | | | | | | | | | | |
| Example 6) | 728 | AS | 709 | AS | 362 | AS | 632 | AS | 793 | AS |

Note for Table 2: *“delam” stands for delamination.

### Examples 9(a)-(c) and Comparative Example M (Control)—Glycerol Phosphate in Mor-Free™ C-117+Mor-Free™ 403A—The Adhesive

In Examples 9(a)-(c) and Comparative Example M (Control), the glycerol phosphate prepared as described in Synthesis Example 1 is added in various amounts to Mor-Free™ C-117 as described in Table D. The resultant glycerol phosphate/Mor-Free™ C-117 polyol blends are mixed using a Flacktek high speed mixer at a speed of 2,000 rpm for 2 min.

TABLE D

| | Mor-Free ™ | Glycerol |
|---|---|---|
| | C117 | Phosphate |
| Example No. | (g) | (g) |
| Control (Comparative Example M) | 100.0 | 0.00 |
| Example 9(a) | 79.9 | 0.10 |
| Example 9(b) | 100.0 | 0.25 |
| Example 9(c) | 100.0 | 1.00 |

Then, 100 parts of the Control consisting of only Mor-Free™ C-117 and each of the glycerol phosphate/Mor-Free™ C-117 polyol blends based on Table D is mixed with 100 parts of Mor-Free™ 403A isocyanate prepolymer to form a reactive adhesive mixture.

### Examples 10(a)-(c) and Comparative Example N (Control)—Glycerol Phosphate in Mor-Free™ C-117+Mor-Free™ 403A—The Laminate (Prelam/GF-19 Film)

The resultant adhesive mixture prepared above in Example 9 is used to prepare sample laminates. The resultant adhesive mixtures prepared in Example 9 are then applied on a Prelam film with a coat weight of 1.07 lbs/ream, followed by laminating the coated Prelam film with a GF-19 film with a Nordmeccanica LaboCombi laminator to form sample laminates for testing. Each of the sample laminates is tested in accordance with the following tests: the bond strength after one day (1-Day Bond), the bond strength after seven days (7-Day Bond), and the bond strength after the boil in bag test. The test results are described in Table 3. After the boil in bag test, the bond strength of the adhesive formulations of the present disclosure is improved compared to the control adhesive formulation.

### Examples 11(a) and 11(b) and Comparative Example O (Control)—Glycerol Phosphate in Mor-Free™ C-79+Mor-Free™ L75-100—The Adhesive

The prepared glycerol phosphate described in Synthesis Example 1 is added in various amounts to Mor-Free™ C-79 as described in Table E. The resultant glycerol phosphate/Mor-Free™ C-79 blends are mixed using a Flacktek high speed mixer at a speed of 2,000 rpm for 2 min.

TABLE E

| | Mor-Free ™ C-79 | Glycerol Phosphate |
|---|---|---|
| Example No. | (g) | (g) |
| Control (Comparative | 60.000 | 0.000 |
| Example O) | | |
| Example 11 (a) | 59.775 | 0.225 |
| Example 11 (b) | 59.100 | 0.900 |

Then, 50 parts of the Control consisting of only Mor-Free™ C-79 and each of the glycerol phosphate/Mor-Free™ C-79 polyol blends based on Table E is mixed with 100 parts of the Mor-Free™ L75-100 isocyanate prepolymer to form a reactive adhesive mixture.

### Examples 12(a) and 12(b) and Comparative Example P (Control)—Glycerol Phosphate in Mor-Free™ C-79+Mor-Free™ L75-100—The Laminate (Prelam/GF-19 Film)

The resultant adhesive mixtures described above in Example 11 are used to prepare sample laminates for testing. Each of the sample laminates is tested in accordance with the following tests: the 1-day bond strength test, the 7-day bond strength test, and the boil in bag test. The test results are described in Table 3. After the boil in bag test, the bond strength of the adhesive formulations of the present disclosure is improved compared to the control adhesive formulation.

### Examples 13(a) and 13(b) and Comparative Example 0 (Control)—Glycerol Phosphate in PacAcel™ CR-85+PacAcel™ L75-191—The Adhesive

The prepared glycerol phosphate described in Synthesis Example 1 is added to PacAcel™ CR-85 in various amounts as described in Table F. The glycerol phosphate/PacAcel™ CR-85 blends are mixed using a Flacktek high speed mixer at a speed of 2,000 rpm for 2 min.

TABLE F

| | PacAcel ™ | Glycerol |
|---|---|---|
| | CR-85 | Phosphate |
| Example No. | (g) | (g) |
| Control (Comparative Example Q) | 60.000 | 0.000 |
| Example 13 (a) | 59.775 | 0.225 |
| Example 13 (b) | 59.100 | 0.900 |

Then, 50 parts of the Control consisting of only PacAcel™ CR-85 and each of the glycerol phosphate/PacAcel™ CR-85 polyol blends based on Table F are mixed with 100 parts of PacAcel™ L75-191 isocyanate prepolymer to form a reactive adhesive mixture.

### Examples 14(a) and 14(b) and Comparative Example R (Control)—Glycerol Phosphate in PacAcel™ CR-85+PacAcel™ L75-191—The Laminate (Prelam/GF-19 Film)

The resultant adhesive mixtures described above in Example 13 are used to prepare sample laminates for testing. Each of the sample laminates is tested in accordance with the following tests: the 1 day bond strength test, the 7 day bond strength test, and the bond strength after boil in bag test. The results of the tests are described in Table 3. After the boil in bag test, the bond strength of the adhesive formulations of the present disclosure is improved compared to the control adhesive formulation.

### Example 15 and Comparative Example S (Control)—Glycerol Phosphate in Mor-Free™ L82-105/Mor-Free™ C33—The Adhesive

The prepared glycerol phosphate prepared as described in Synthesis Example 1 is added to Mor-Free™ L82-105 in the amount described in Table G. The glycerol phosphate is not added to the Control. The glycerol phosphate/Mor-Free™ L82-105 polyol blend is mixed using a Flacktek high speed mixer at a speed of 2,000 rpm for 2 min.

TABLE G

| | Mor-Free ™ | Glycerol |
|---|---|---|
| | L82-105 | Phosphate |
| Example No. | (g) | (g) |
| Control (Comparative | 100 | 0 |
| Example S) | | |
| Example 15 | 100 | 0.2 |

Then, 100 parts of the control consisting of only Mor-Free™ L82-105 and the glycerol phosphate/Mor-Free™ L82-105 polyol blend described in Table G is mixed with 60 parts of Mor-Free™ C-33 isocyanate prepolymer to form a reactive adhesive mixture.

### Example 16 and Comparative Example T (Control)—Glycerol Phosphate in Mor-Free™ L82-105/Mor-Free™ C33—The Laminate (Prelam/GF-19 Film)

The resultant adhesive mixtures described above in Example 15 are used to prepare sample laminates on Prelam/GF19 structure for testing. The resultant sample laminates are tested in accordance with the following tests: the 1-day bond strength test, the 7-day bond strength test, and the boil in bag test. The test results are described in Table 3. After the boil in bag test, the bond strength of the adhesive formulations of the present disclosure is improved compared to the control adhesive formulation.

TABLE 1
Performance for Laminates of Prelam//GF19 Structures From Examples 9-16

| | | | | | Boil in Bag | |
|---|---|---|---|---|---|---|
| | 1 Day Bond | | 7 Day Bond | | (1:1:1) | |
| Example | T-Peel | | T-Peel | | T-Peel | |
| No. | (gm/2.54 cm) | FM | (gm/2.54 cm) | FM | (gm/2.54 cm) | FM |
| Control (Comparative | 840 | AS | 1,065 | FS | 29 | AS |
| Example N) | | | | | | |
| Mor-Free ™ C-117 + | | | | | | |
| Mor-Free ™ 403A | | | | | | |
| Example 10(a) | 1,306 | FS/AT | 1,285 | FS/AS | 450 | AT |
| Example 10(b) | 1,291 | FS | 1,162 | FS/FT | 885 | FS |
| Example 10(c) | 1,288 | FS | 1,084 | FS | 963 | FS |
| Control (Comparative | 546 | AT | 555 | AT | 150 | AS |
| Example P) | | | | | | |
| Mor-Free ™ C-79 + | | | | | | |
| Mor-Free ™ L75-100 | | | | | | |
| Example 12 (a) | 772 | AT | 835 | AT | 782 | AT |
| Example 12 (b) | 727 | AT/AS | 1,148 | FT | 614 | AS |
| Control (Comparative | 458 | AT | 481 | AT | 181 | AT |
| Example R) | | | | | | |
| PacAcel ™ CR-85 + | | | | | | |
| PacAcel ™ L75-191 | | | | | | |
| Example 14 (a) | 679 | AT | 538 | AT | 763 | AT |
| Example 14 (b) | 707 | AT | 645 | AT | 604 | AS |
| Control (Comparative | 287 | AS | 269 | AT | 81 | AT/DL |
| Example T) | | | | | | |
| Mor-Free ™ L82-105/ | | | | | | |
| Mor-Free ™C-33 | | | | | | |
| Example 16 | 82 | AS | 374 | AT | 291 | AT |

From the results in Table 3, it can be concluded that the boil in bag resistance of the adhesive used in the sample laminates of Examples 9-16 improve significantly with the addition of the glycerol phosphate additive.

### Synthesis Example 2—Synthesis of Glycerol Phosphate Using Solvent Extraction

In Synthesis Example 2, a glycerol phosphate is prepared by reacting glycerol phosphate disodium salt with an acid followed by solvent extraction. The prepared glycerol phosphate is used as an additive in C-411/L75-164. The reaction is started by first dissolving 20 g of glycerol phosphate disodium salt in 30 g of DI water in a 120 ml glass bottle; and then 47.3 g of 1M H₂SO₄ is added to the aqueous solution of glycerol phosphate disodium salt/DI water to lower the solution pH to 2.4. Next, excess methanol is added to the aqueous solution; and a white powdery precipitate is observed to form in the solution. The precipitate is separated from the aqueous solution by filtering the solution with a 5-micron nylon syringe filter. Thereafter, methyl ethyl ketone (MEK) is added to the recovered solution; and a clear viscous liquid is found to settle at the bottom of the 120 ml glass bottle. The clear viscous liquid is isolated and dried and used as the glycerol phosphate additive.

### Synthesis Example 3—Synthesis of Glycerol Phosphate Using Polyphosphoric Acid

In Synthesis Example 3, a glycerol phosphate is prepared by reacting glycerol with polyphosphoric acid. The prepared glycerol phosphate is used as an additive in C-411/L75-164. The reaction is initiated by first adding 13.3 g of polyphosphoric acid (PPA) and 23.1 g of glycerol into a 500 ml resin kettle at room temperature. The resultant mixture is then stirred at room temperature using an overhead mixer. A moderate exotherm is observed with a temperature increase of up to 51° C. within 7 min. The mixture is then heated at 65° C. for 45 min. A clear viscous liquid formed in the resin kettle and thereafter the viscous liquid is isolated into 120 ml glass jar.

### Synthesis Example 4—Synthesis of Glycerol Phosphate Using Phosphoric Acid Crystals

In Synthesis Example 4, a glycerol phosphate is prepared by reacting glycerol with phosphoric acid crystals. The reaction is initiated by first adding 22.1 g glycerol, 23.5 g of phosphoric acid crystals, and 30 mL of heptane into a 500 ml resin kettle at room temperature. The resultant mixture is then heated at 80° C. for 8 hr. The heptane is decanted off and a slight yellow viscous liquid recovered after decantation. The prepared glycerol phosphate is used as an additive in an adhesive reactive mixture of MOR-FREE™ C-411 and MOR-FREE™ L75-164.

### Examples 17-19—Glycerol Phosphate Used with C-411/L75-164—The Adhesives

In Examples 17-19, 0.88 gm of each of the glycerol phosphate compounds prepared as described in Synthesis Examples 2-4 is added to 49.12 gm of Mor-Free™ C-411 polyol. The blends are mixed using a Flacktek high speed mixer at a speed of 2,000 rpm for 2 min. Then, 40 parts of each of the glycerol phosphate/Mor-Free™ C-411 polyol bends prepared in Examples 2-4 are mixed with 100 parts of the Mor-Free™ L75-164 isocyanate prepolymer to form a reactive adhesive mixture.

### Examples 20-22—Glycerol Phosphate Used with C-411/L75-164—The Laminates (Prelam/GF-19 Film)

Each of the resultant glycerol phosphate/Mor-Free™ C-411 polyol/Mor-Free™ L75-164 isocyanate prepolymer adhesive mixtures prepared in Examples 17-19 is then applied on a Prelam film with a coat weight of 1.07 lbs/ream, followed by laminating the coated Prelam film with GF-19 film using a Nordmeccanica LaboCombi laminator to form laminate samples. The sample laminates are tested for the bond strength after one day, the bond strength after seven days, boil in bag and chemical aging. The results are described in Table 4.

TABLE 2
Performance for the Laminates of Prelam//GF19 Structure for Examples 20-22

| | 1-Day Bond | | 7-Day Bond | | Boil-in-Bag | | Chemical Aging | |
|---|---|---|---|---|---|---|---|---|
| Example | T-peel | | T-Peel | | T-Peel | | T-Peel | |
| No. | (g/2.54 cm) | FM | (g/2.54 cm) | FM | (g/2.54 cm) | FM | (g/2.54 cm) | FM |
| Example 20 | 620 | AT | 710 | AT | 518 | AT | 89 | AS |
| Example 21 | 773 | AT | 663 | AT | 1,027 | AT/FS | 1,238 | AT/FS |
| Example 22 | 732 | AT | 513 | AT | 683 | AT | 1,110 | AT/FS |

From the test results described in Table 4, it can be concluded that the bond strength, after the boil in bag testing and the chemical aging testing, can be improved significantly by using the adhesive formulation of the present disclosure containing the glycerol phosphate prepared in Synthesis Examples 2-4.

### Examples 23-25—Glycerol Phosphate Used with C-411/L75-164—The Laminate (Prelam/CPP Film)

Each of the resultant glycerol phosphate/Mor-Free™ C-411 polyol/Mor-Free™ L75-164 isocyanate prepolymer adhesive mixtures prepared as described in Inv. Ex. 17-19 is applied on a Prelam film with a coat weight of 1.07 lbs/ream, followed by laminating the coated Prelam film with a 3-mil CPP film with a Nordmeccanica LaboCombi laminator to form laminate samples.

The Prelam/3-mil CPP laminate structures used in these Examples, are prepared from CPP slip sheets. Specifically, during the routine solventless laminating process on the LaboCombi machine, for each roll, seven CPP slip sheets with the size of 12 inches×20 inches are sent through the nipping window and laminated in between the primary (Prelam) and secondary film (CCP sheets) with the corona treated side towards the primary (Prelam) film.

The resultant Prelam/CPP laminates bonded with the adhesives of the present disclosure are tested for the bond strength after the one-day bond strength test, the seven-days bond strength test, the boil in bag test, and the chemical aging test. The test results are described in Table 5.

TABLE 5
Performance for the Laminates of Prelam//3-mil CPP Structure for Examples 23-25

| | 1-Day Bond | | 7-Day Bond | | Boil-in-Bag | | Chemical Aging | |
|---|---|---|---|---|---|---|---|---|
| Example | T-Peel | | T-Peel | | T-Peel | | T-Peel | |
| No. | (g/2.54 cm) | FM | (g/2.54 cm) | FM | (g/2.54 cm) | FM | (g/25.4 cm) | FM |
| Example 23 | 864 | AT | 964 | AT | 703 | AT | 127 | AS |
| Example 24 | 1,058 | AT | 935 | AT | 878 | AT | 1,411 | AT |
| Example 25 | 1,079 | AT | 779 | AT | 496 | AT | 1,088 | AT |

From the results described in Table 5, it can be concluded that that boil in bag resistance property of the laminates improved significantly for Examples of 23-24 and chemical aging resistance property of the laminates improved significantly for Examples of 24 and 25.

1. A two-component solventless adhesive composition, comprising:
(a) at least one isocyanate component comprising an isocyanate-terminated polymer; and
(b) at least one isocyanate-reactive component being reactive with the at least one isocyanate component; wherein the at least one isocyanate-reactive component comprises a material having at least two functional groups including:
(b′) at least one first functional group; wherein the at least one first functional group is selected from the group consisting of: at least one phosphate ester functional group, at least one phosphonic acid functional group, and mixtures thereof, and
(b″) at least one second functional group reactive with the at least one isocyanate component; wherein the least one second functional group is selected from the group consisting of: at least one hydroxyl functional group, at least one carboxylic acid functional group, and mixtures thereof, and
(c) optionally, at least one bio-based polyol.

2. The two-component solventless adhesive composition of claim 1, wherein the at least one isocyanate component comprises an isocyanate-terminated prepolymer; wherein the isocyanate-terminated prepolymer comprises a reaction product of (ai) an excess of at least one polyisocyanate; and (aii) at least one polyol.

3. The two-component solventless adhesive composition of claim 1, wherein the at least one bio-based polyol component comprises at least one polyol component selected from the group consisting of a polyether polyol, a polyester polyol, and mixtures thereof.

4. The two-component solventless adhesive composition of claim 1, wherein the at least one polyisocyanate component is 4,4′-methylene diphenyl diisocyanate, 2,4′-methylene diphenyl diisocyanate, and optionally 2,2′-methylene diphenyl diisocyanate.

5. The two-component solventless adhesive composition of claim 1, wherein the at least one isocyanate-reactive component comprises a mixture of:
(bi) at least one hydroxy-terminated polyurethane resin;
(bii) at least one polyether polyol;
(biii) at least one phosphate ester adhesion promoter; and
(biv) optionally, at least one bio-based polyol.

6. The two-component solventless adhesive composition of claim 5, wherein the at least one phosphate ester adhesion promoter is made from a tri-functional glycol and a polyphosphoric acid; wherein the phosphate ester adhesion promoter has a phosphoric acid content of less than 3 weight percent, based on the weight of the phosphate ester adhesion promoter.

7. The two-component solventless adhesive composition of claim 1, wherein the at least one bio-based polyol component is castor oil.

8. The two-component solventless adhesive composition of claim 1, wherein the mole ratio of the NCO groups present in the at least one isocyanate component to the OH groups present in the at least one isocyanate-reactive component is from 1.1 to 1.6.

9. A method of preparing a two-component solventless adhesive composition, comprising mixing:
(a) at least one isocyanate component comprising an isocyanate-terminated polymer; and
(b) at least one isocyanate-reactive component being reactive with the at least one isocyanate component; wherein the at least one isocyanate-reactive component comprises a material having at least two functional groups including:
(b′) at least one first functional group; wherein the at least one first functional group is selected from the group consisting of: at least one phosphate ester functional group, at least one phosphonic acid functional group, and mixtures thereof, and
(b″) at least one second functional group reactive with the at least one isocyanate component; wherein the least one second functional group is selected from the group consisting of: at least one hydroxyl functional group, at least one carboxylic acid functional group, and mixtures thereof.

10. A laminate structure comprising the two-component solventless adhesive composition of claim 1.

11. A packaging material comprising the laminate of claim 10.
